(19) United States
(12) Patent Application Publication
(10) Pub. No.: US 2007/0041707 A1
(43) Pub. Date: Feb. 22, 2007

(54) Video receiver, transmission apparatus and method of providing a representative image

(76) Inventors: Timothy Edmunds, Mid Glamorgan (GB); Simon Waller, Basingstoke (GB)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/208,054

(22) Filed: Aug. 19, 2005

(51) Int. Cl. H04N 7/00

(52) U.S. Cl. 386/95

(57) ABSTRACT

There is provided a method of providing a receiver of a transmitted stream of video data for an ongoing succession of video frames with one or more images representing that stream of video data. Indicator data is created which identifies individual frames in the stream of video data for use as the one or more images. The indicator data is then transmitted to the receiver and used by the receiver to capture frames for use as representative images. The representative images may be used as part of an electronic program guide, for instance when the frames are captured from earlier transmitted trailers. Also, the representative images can be used when recording a received transmitted program, in particular in conjunction with indexing information for playback of the recorded program.

### BACKGROUND OF THE INVENTION

1. Field of the Invention

The present invention relates to a method of providing to the receiver of a transmitted stream of video data for a succession of video frames one or more images representing the video data, for instance for display as part of an index.

2. Description of the Related Art

It is known to record transmitted and broadcast television programs locally at an end-user device. Television programs are transmitted as a stream of video data including an ongoing succession of video frames. The video data may be in an analog or digital form For a recorded program, it has been proposed to provide indexing images, sometimes in the form of what is known as “thumbnails”. In this way, when a user accesses the previously recorded data, for instance from a disk, such as a DVD, the user is presented with the representative image so as to remind him or her of the content of the recorded television program This may be extended to provide a plurality of representative images, each representing a respective section or “chapter” of the recorded television program.

Previously, it has been proposed to transmit, in addition to the stream of video data, image data for the representative images, together with time-information data lining those representative images with the respective television program or section/chapter within that program This has the disadvantage of consuming valuable bandwidth when transmitting information to the end user.

It is also known to provide to end users electronic program guides which list the various television programs to be transmitted. In this context, it is similarly desirable to provide a representative image or thumbnail of the television program to be transmitted so as to give the user an immediate impression of the content of the television program It may also be desirable to provide images for use in the electronic program guide, the images representing the respective television channels themselves. Transmitting, with the electronic program data, image data representing a particular television program or television channel consumes valuable bandwidth.

### OBJECTS OF THE INVENTION

It is an object of the present invention to provide video transmission/reception methods and devices that provide the features discussed above whilst reducing the problems of consumed bandwidth.

### SUMMARY OF THE INVENTION

The present invention provides a video receiver device comprising an input interface for receiving external data, a receiver connected to the input interface for obtaining from the external data a stream of video data for a succession of video frames, such as an onging succession of video frames, an output interface connected to the receiver for outputting the stream of video data and a detector for detecting indicator data in the external data. The indicator data indicates at least one frame of the stream of video data for use in representing the video data. A memory is provided for storing a plurality of video frames. A data capturer is connected to the receiver and the memory and is arranged to capture individual video frames from the stream of video data and store captured frames in the memory. A controller is connected to the detector, the data capturer and the memory and is responsive to detection by the detector of indicator data to control the data capturer to capture the frames indicated by the detected indicator data and store the captured frames in memory. An image provider is connected to the memory, the output interface and the controller, the image provider being responsive to the controller to obtain selected frames from the memory and provide the selected frames to the output interface for use in representing the stream of video data.

The present invention also provides a method for identifying one or more video frames in an external stream of video data and for providing data corresponding to one or more frames of the video data stream to an output interface for use in representing a portion of the video data stream The method comprises the steps of receiving the external data stream and deriving the video data stream therefrom, detecting indicator data in the external data, the indicator data indicating at least one frame of the stream of video data for use in representing the video data, storing a plurality of video frames, capturing one or more individual frames in accordance with the detected indicator data and providing one or more captured frames to an output interface.

The present invention also provides a video device comprising an input interface for receiving external data, a receiver connected to the input interface for obtaining from said external data a stream of video data for a succession of video frames, an output interface connected to the receiver for outputting the stream of video data and a detector for detecting indicator data in the external data. The indicator data indicates at least one frame of the stream of video data for use in representing the video data. A controller is connected to the detector and is arranged to control the detector to provide the indicator data to the output interface for output with the stream of video data.

The video data and indicator data can be retrieved from a recording medium with the indicator data being used to identify frames for capture from the video data, those frames being used for representing the stream of video data.

Thus, the present invention also provides a method for generating a representation of a video data item stored on a recording medium, the video data item having a plurality of successive video frames and the representation being for display using a graphical user interface. The method comprises reading from the recording medium prerecorded indexing data for identifying the video frames of the video data item, reading from the recording medium prerecorded indicator data for indicating at least one frame of the video frames of the video data item for use in generating the representation and using the indicator data identifying at least one video frame included in the video data item. The method also comprises launching a graphical user interface application and outputting the at least one video frame to an interface accessible by the graphical user interface application. A representation of the video data item stored on the recording medium is then displayed in the graphical user interface, the representation including or at least being based on one or more video frames of the video data item obtained from said interface by means of the indexing data.

Thus, a receiver device is able to provide representative images without those images themselves having been transmitted separately. It is thus not necessary to provide a special channel for transmitting the representative images and bandwidth is saved.

In one embodiment, the controller is configured to provide, in conjunction with the image provider, output data for display of an electronic program guide and is configured to insert, into the electronic program guide, frames indicated by the indicator data for respective programs listed in the electronic program guide.

In this way, an electronic program guide is able to provide representative images, for instance thumbnails of the programs listed, without the need for additional bandwidth to transmit those images to the receiver.

The controller may be configured to insert into the electronic program guide, for respective programs, frames captured from streams of video data for trailers for those respective programs.

This allows the electronic program guide to make use of frames of video data which are being transmitted irrespective of the electronic program guide.

The present invention thus also relates to a method of providing representative images for display in an electronic program guide in conjunction with a television program listing, the method including transmitting indicator data identifying frames in streams of video data for trailers of television programs representative of forthcoming television programs and using the identified frames for the representative images.

The present invention also provides an electronic program guide comprising a program listing including for respective programs program times and program names and further comprising indicator data for identifying, in a stream of video data, video frames for use as representative images, whereby the electronic program guide is configured to display the representative images in conjunction with listed programs.

Other representative images can be provided in the electronic program guide, for instance the logos of the channel or the television company. Similarly, logos or images from advertisers can be provided for display in the electronic program guide. If these images are at some time transmitted in the main stream of video data, they can be captured by means of the indicator data and used in the electronic program guide.

The representative images can also be used in forming a recorded index for the recording of a transmitted television program. The index may be stored on a mass storage device of a Personal Video Recorder (PVR) such as a hard disc drive or on a removable media such as a recordable DVD or Blu-Ray Disc (TM). In some implementations, the index may be stored in part on hard disc or removable media and in part on a separate storage medium such as semi-conductor memory. Typically, index data comprises a table of contents, the representative images may be stored in or be referenced by the table of contents.

Hence, for a received stream of video data for a television program, the controller is configured to provide for output, in conjunction with the image provider, index data for the television program including said selected frames for the television program

This index data can be recorded together with the television program to provide to the user, upon playback, an index of the recorded television program including at least one representative image. Where the television program includes a number of different sections or chapters, respective representative images can be provided for those sections or chapters.

The memory can be arranged to store the plurality of video frames in full resolution as received from the receiver. Alternatively, the controller may be configured to produce thumbnail video frames of reduced size and/or resolution for storage as the video frames in the memory. Full resolution images may or may not be retained in memory as well as those of reduced size/resolution.

In some embodiments, the raw indicator data can be recorded with the television program The playback device then uses the indicator data to obtain from the video data of the television program suitable representative images.

The present invention also provides a video device comprising an input interface for receiving external data, a receiver connected to the input interface for obtaining from the external data a stream of video data for a succession of video frames and a detector for detecting indicator data in the external data. The indicator data indicates at least one frame of the stream of video data for use in representing the video data. A recorder is provided and arranged to receive from the receiver and the detector the stream of video data and indicator data and to record the stream of video data and indicator data on a recording medium.

The input interface may be arranged to receive external data containing the indicator data from a different source to external data containing the stream of video data. For instance, the indicator data may be received over a network, such as the internet. Alternatively, where the indicator data is provided in the same video stream, the receiver is preferably arranged to separate external data containing the indicator data from external data containing the stream of video data.

The present invention may be embodied in an integrated television receiver, a PC and the like. Hence, in some embodiments, it may include a display for displaying at least the stream of video data.

The video receiver device may further include a recording apparatus for recording at least the stream of video data. Hence, the present invention may be embodied in a recording device, such as a DVD recorder or a personal video recorder.

The present invention provides a video receiver device for receiving a stream of video data for a succession of video frames and for receiving indicator data identifying frames of the video data, the device including a controller responsive to receipt of indicator data to cause the video receiver device to capture frames identified by received indicator data and to output images derived from the captured frames for representing respective parts of the stream of video data.

Thus, in the context of recording a received transmitted television program, the present invention also provides a method of providing representative images for recording with a recording of a transmitted television program and for subsequent use in an index for the recorded television program, the method including transmitting indicator data identifying frames of transmitted streams of video data for television programs and obtaining from the frames identified by the indicator data the representative images.

A method may also be provided further including creating index data for the recorded television program using the representative images obtained from the identified frames.

According to another aspect of the present invention, there is provided a video transmission apparatus comprising an input interface for providing, from a source, a stream of video data for a succession of video frames, such as an ongoing succession of video frames. An output interface is connected to the input interface and is arranged to provide the stream of video data for transmission. A user interface is connected to said input interface and is arranged to provide a display of video frames of said stream and to enable a user to select particular frames for use in representing the stream. An indicator creator is connected to the input interface, the user interface and the output interface, wherein the indicator creator is arranged to create, in response to control from the user interface following selection of particular frames by a user, indicator data indicating at least one frame as selected by the user from the stream of video data and to provide the indicator data to the output interface.

Thus, a user/operator at the transmitting side can decide on appropriate frames for use as representative images and the video transmission apparatus transmits corresponding indicator data allowing the reception side to capture the selected frames for those representative images. Representative images may have been determined in advance by the editor or producer of a TV program. Alternatively, representative images may be determined automatically by algorithmic analysis of the video data.

The output interface may be arranged to embed the indication data in the stream of video data. Alternatively, the output interface may be arranged to provide a data stream containing the indicator data for transmission with the stream of video data. As noted above, it is also possible for the indicator data to be transmitted by means of a different transmission path, such as a network. Hence, the output interface may be arranged to provide output data containing the indicator data for transmission separately from the stream of video data.

The present invention thus provides a transmission or broadcast stream comprising a stream of video data for an ongoing succession of video frames and indicator data indicating at least one frame of the stream of video data for use in representing the or another stream of video data.

The present invention also provides a data carrier having stored thereon data portions corresponding to at least one sequence of video frames. Table-of-contents data identifies the data portions and data representing one or more video frames corresponding to at least some data portions. The data representing the one or more video frames is displayable as part of an index display of the contents of the data carrier. It is stored on the data carrier in accordance with the present invention.

The present invention also provides a method of providing a receiver of a transmitted stream of video data for an ongoing succession of video frames with one or more images representing the stream of video data, the method comprising creating indicator data which identifies individual frames in the stream of video data for use as said one or more images; and transmitting said indicator data to the receiver.

### BRIEF DESCRIPTION OF THE DRAWINGS

FIG. 1 illustrates schematically the transmission and reception paths of a system embodying the present invention;

FIG. 2 illustrates schematically parts of the transmitted data streams;

FIG. 3 illustrates schematically a transmission apparatus embodying the present invention;

FIG. 4 illustrates schematically a receiving device embodying the present invention; and

FIG. 5 illustrates schematically an alternative device embodying the present invention.

### DETAILED DESCRIPTION OF THE PREFERRED EMBODIMENTS

The invention will be more clearly understood from the following description, given by way of example only, with reference to the accompanying drawings.

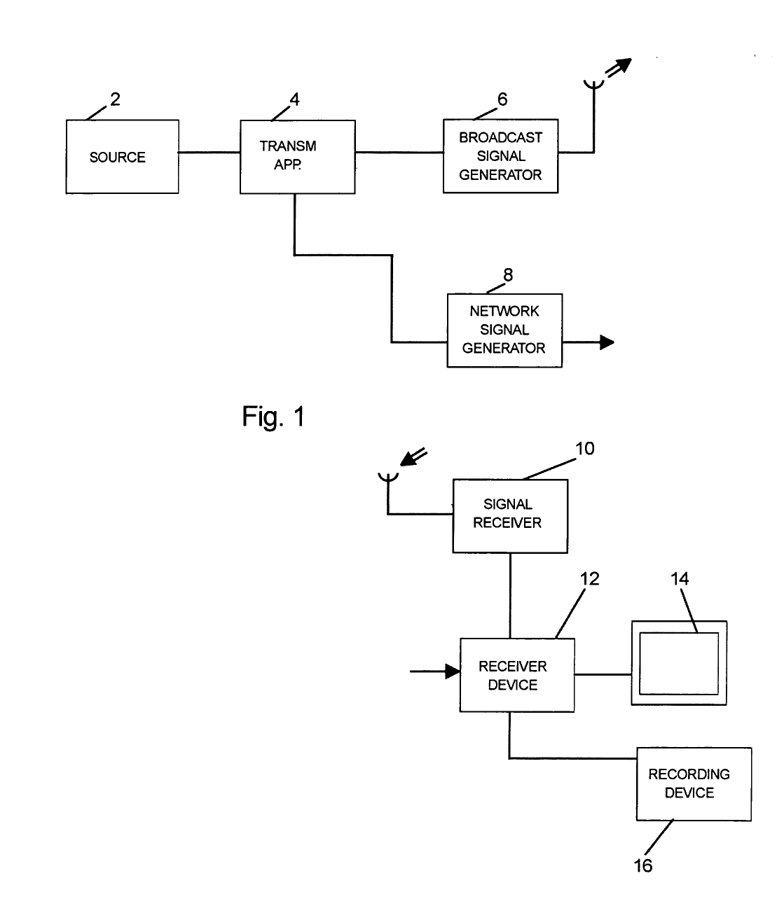

FIG. 1 illustrates schematically a broadcast system in which the present invention may be embodied. At the broadcast side, a source 2 of various live and pre-recorded audio/video sequences is available. A transmission apparatus 4 is available to a production team to choose and arrange various audio/video sequences for transmission. This may include inserting various commercials and trailers for future television programs. The resulting stream of data is provided to a broadcast signal generator 6 for transmission by any suitable means, such as aerial, satellite, cable, etc. In the illustrated embodiment, the transmission apparatus 4 is also able to output data to a network signal generator 8. The network signal generator 8 generates information for access by an end user over a network, such as the internet. The network signal generator 8 may have access to or include a server connected to the network.

At the receiver end, the broadcast signal is received, for instance via an aerial, satellite dish or cable, by a signal receiver 10 where it may be demodulated, decoded, etc as required.

A video receiver device 12 receives the external signal from the signal receiver 10 The video receiver device 12 then outputs a stream of video data, as selected by the receiver end-user, to a display device 14 and/or a recording device 16.

In the illustrated embodiment, the video receiver device 12 is also configured to obtain external data from other sources, such as a network, for instance the internet.

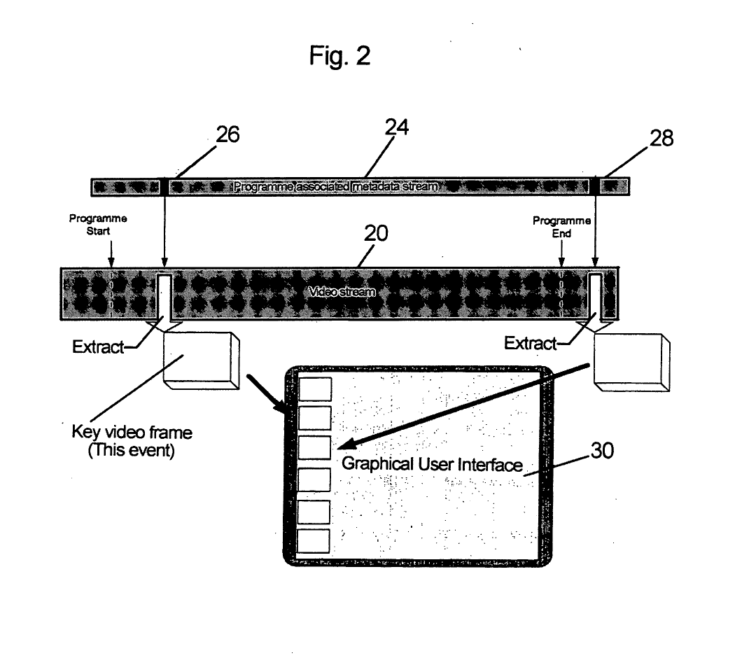

FIG. 2 illustrates schematically a process embodying the present invention.

The transmitter apparatus 4 generates a meta-data stream in conjunction with the video-data stream The meta-data stream may be one of many types of known data stream and may include various data, some of which is of no direct interest to the present invention.

The transmitter apparatus inserts into the meta-data stream indicator data which identifies a particular frame (or possibly a series of frames) contained in the stream of video data, that or those frames representing that stream of video data in which it or they are contained. Hence, the meta-data stream does not itself include image data for providing an image representative of the stream of video data, but it includes an identification of an appropriate frame within the stream of video data for use in representing that stream of video data.

Where a series of frames is to be identified, indicator data may be provided that indicates a starting point and a different indicator may be provided as an end point. These may be repeated over a short sequence of frames in case of corruption of the indicator data Alternatively, the same marker is used for the whole series of frames, one for each frame.

In an analog environment, the meta data including the indicator data can be included for instance in the vertical blanking period of the video signal. Because the analog video signal will not normally include timing data for identifying individual frames, it is not possible for the indicator data to include usefully such data. Instead, it is proposed that the indicator data signals to a receiver device to use the frame following the indicator data either directly or by an indicated or predetermined number of frames.

In a digital environment, each frame of a stream of video data is usually uniquely identified by some form of timing code. In this case, it is possible for the indicator data to identify the required frame from the stream of video data uniquely by means of this code. The indicator data can thus be provided quite separately, within or outside the meta-data stream, from the stream of video data.

In many digital systems, program-associated meta data is transmitted with the stream of video data in a time-multiplexed manner and then separated by the receiving apparatus. Alternatively, the program-associated meta data could be provided on a separate channel. Indeed, the indicator data of the present invention, whether or not included with the program-associated meta data, could be provided as external data transmitted via a different transmission path, for instance via a network such as the internet or even supplied in advance on a recording medium, perhaps sold with a printed listing of TV schedules.

FIG. 2 illustrates schematically the video stream 20 of a first program and the start of the video stream 22 of a second program. The program-associated meta-data stream 24 includes indicator data which acts as a pointer to the data of the stream of video data required to produce an image of one frame representative of the respective program. As illustrated, first indicator data 26 includes a pointer to the required data in the video stream 20. Similarly, second indicator data 28 points to data for a frame representing the video stream 22.

Where the video stream 20 of the first program is being recorded, the representative image frame(s) identified by the indicator data 26 can also be recorded, either in its fill resolution or as a miniaturized thumbnail version. In alternative embodiments, the video stream 20 is recorded and the indicator data 26 is stored. Either once recording is complete or during the recording, the representative image frame(s) are derived from the recorded file or files and are stored. In further alternative embodiments, the indicator data is used to identify representative frame(s) from the recorded file(s) as and when required (for example when used to display an index of recorded video sequences). It is not necessary to store the representative images(s) in addition to the recorded files. When accessing previously recorded programs, the user can be provided with a display, such as display 30, in which the representative images are displayed so as to represent the recorded programs available for playback.

It will be appreciated that where a program is divided into various sections or chapters, indicator data can be provided for each section or chapter so as to identify representative frames for those sections or chapters. In this way, the display 30 can show not only images representing individual respective programs, but also images representing sections or chapters within those programs. As is well known for DVD playback menus, the user can select playback of a particular program, section or chapter by operating a user interface in conjunction with the displayed representative images, usually by highlighting an image and selecting whichever representative image is highlighted.

In one embodiment, the indicator data can be used to identify a small series of representative images which can subsequently be displayed on the display 30 as a short moving video sequence rather than a still image.

It is possible for the recording device merely to record the indicator data. When the user accesses the recorded video data for playback, the playback device then uses the indicator data to create the required representative images. However, since this requires the playback device to be configured accordingly, in the preferred embodiment, the representative images themselves are recorded with the video data, preferably in a format recognizable by conventional playback devices configured to display representative images such as thumbnails.

It is known to provide to an end user an electronic program guide which provides information regarding the transmission of future television programs. In particular, the electronic program guide will contain a list of the various television programs identified by name, together with their transmission times and, optionally, other information such as a synopsis of the program.

It is thought to be desirable additionally to provide thumbnail images representative of the television programs in the electronic program guide.

According to one embodiment of the present invention, this may be achieved using indicator data as discussed above.

For many transmitted television programs, there will have been transmitted in advance a trailer for that program In other words, the service provider will have transmitted a short video sequence that summarizes and advertises the forthcoming full television program. When such a trailer is transmitted, indicator data can be transmitted to the end user as described above indicating to the video receiver device one or more of the frames of the trailer which are not only representative of the video sequence of the trailer but are also for use as one or more representative images for the forthcoming television program.

The electronic program guide is thus configured to allow the display of representative images in conjunction with listed television programs and, in accordance with detection of indicator data, the video receiver device hosting and displaying the electronic program guide, captures the respective frames from the video stream of the trailer and provides these to the electronic program guide for display.

The electronic program guide can be arranged to maintain only the acquired representative image or could be able to update the image displayed as the representative image for a particular program whenever new indicator data appears.

The electronic program guide can also be configured to display other information, such as the respective logos of the various broadcast channels. In this respect, it is very common for the video stream transmitted for a particular program channel to include occasionally the logo of that channel so as to indicate the program channel currently being watched. For instance, before the start of a program, the television company may transmit in full screen their logo for some seconds so as to indicate the program channel being watched. By providing indicator data that point to the image frames occurring at these times during transmission of the stream of video data, the video receiver device can acquire an appropriate image for display in an electronic program guide as the logo of the program channel. Thus, the image may be provided to the electronic program guide for appropriate display.

In some commercial environments, particular programs are broadcast in association with sponsoring companies having their own logos. It may be desirable to display these logos with the electronic program guide in conjunction with the television program listing.

In a similar manner to that discussed above, indicator data can be used to direct the video receiver device to appropriate frames of advertisements for the sponsor as transmitted in the stream of video data. In this way, the video receiver device can acquire appropriate image frames for use by the electronic program guide. In other words, the image frames acquired from the transmitted video stream can be used as thumbnails in the electronic program guide. When sponsors change, new indicator data can direct the video receiver device to new images taken from different advertisements.

It will be appreciated that the electronic program guide can be provided in a meta-data stream transmitted with the stream of video data. However, it can also be provided via a different channel, such as over the internet. Similarly, as discussed above, the indicator data can be provided with the stream of video data or via a separate channel, such as over the internet.

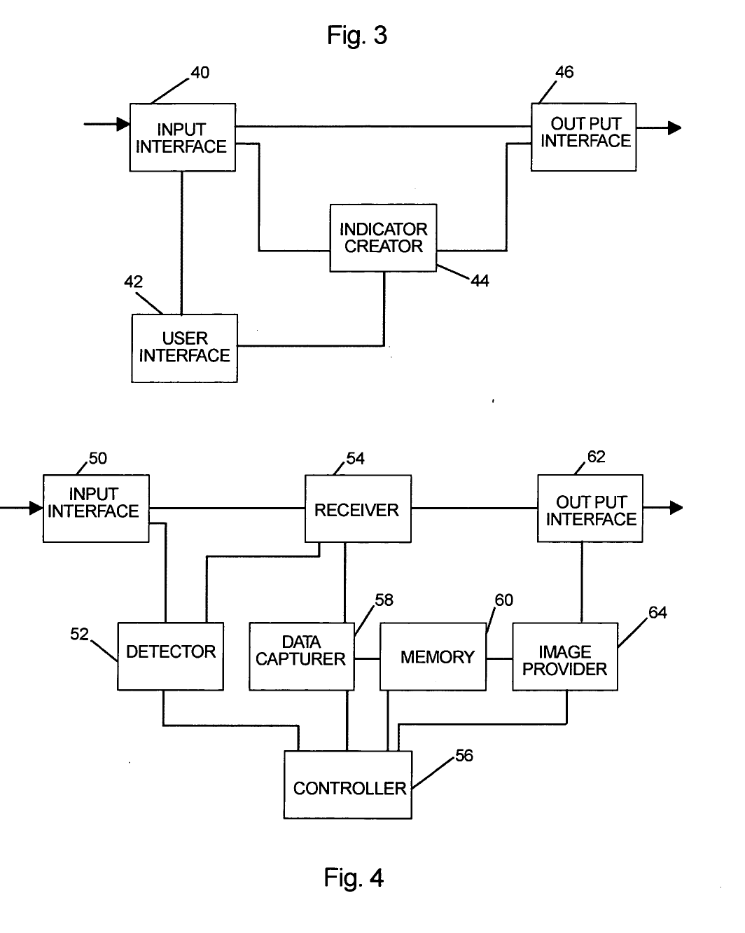

FIG. 3 illustrates schematically a video transmission apparatus for instance as may be used in the arrangement of FIG. 1. An input interface 40 acts as a source of video data and is under control of a user interface 42 to acquire appropriate streams of video data, for instance from the source 2 of FIG. 1.

The user of the transmission apparatus can choose appropriate frames in streams of video data for use at a receiver device as described above. The user interface 42 allows selection of a frame and an indicator creator 44, in communication with the input interface 40 and user interface 42, creates appropriate indicator data.

Both the input interface 40 and the indicator creator 44 are connected to an output interface 46 which is arranged to provide streams of video data for transmission, for instance by passing them to the broadcast signal generator 6 of FIG. 1. The indicator data produced by the indicator creator 44 can be inserted into the output data stream at the output interface 44 or, alternatively, can be routed by the output interface 44 to an alternative data channel, such as the internet.

FIG. 4 illustrates schematically a video receiver device as might be used for the video receiver device 12 of FIG. 1.

An input interface 50 is arranged to receive input external data including at least a transmitted stream of video data. In one embodiment, it may be sufficient to receive additional data, such as indicator data from only the same source as the stream of video data, but, in other embodiments, the input interface 50 may additionally receive data from other sources, such as the internet or even a recording medium.

A detector 52 is configured to detect any indicator data in the external data received by the input interface 50.

A receiver 54 obtains, from the external data received by the input interface 50, a stream of video data. The detector 52 may be able to detect received indicator data directly from the input interface 50, for instance where the indicator data is received separately via the internet or a recording medium. However, in some embodiments, the detector 52 may have to refer to the video data obtained by the receiver 54, for instance where indicator data is provided in vertical blanking periods of the television signal. In the embodiment as illustrated in FIG. 4, the detector 52 is connected both to the input interface 50 and the receiver 54 so as to allow for either situation.

A controller 56 is connected to the detector 52 and also to a data capturer 58. On the basis of indicator data detected by the detector 52 and the frames indicated by the indicator data, the controller 56 controls the data capturer 58 to capture, from the stream of video data obtained by the receiver 54, the data for the frames indicated by the indicator data.

As illustrated, the data capturer 58 is connected to a memory 60. Under the control of the controller 56, frames captured by the data capturer 58 can be stored in the memory 60.

An output interface 62 is connected to the receiver 54 and allows output of received television programs, for instance to a display device or a recorder, such as the display 14 or recorder 16 of FIG. 1. An image provider 64 is connected to the memory 60 and the output interface 62. The image provider 64 is under the control of the controller 56 to provide images obtained from the frames stored in the memory 60 to the output interface 62. These images may be full resolution or reduced in size as thumbnails.

In one preferred embodiment, the controller 56 and image provider 64 may be configured to provide as an output indexing information to an external recorder, such as recorder 16 of FIG. 1. In this way, a television program recorded by the recorder 16 is recorded together with index information including the representative images as signaled by the indicator data received with the external data.

In another embodiment, the controller may be configured to provide, for output at the output interface 62, a signal for displaying an electronic program guide. In particular, the controller 56 can receive data for the electronic program guide via the input interface 50 either from data transmitted with the video data or data received from an alternative source, such as the internet. The electronic program guide signal is provided at the output interface 62, for instance for display on a display such as display 14 of FIG. 1. When creating the electronic program guide, the controller can use images from the image provider 64 for thumbnails in the electronic program guide display, for instance as representative images of television programs, channel logos, sponsor logos, etc.

The receiver device may be embodied in any suitable apparatus, such as an integrated television, a set-top box, a DVD recorder, a hard drive recorder such as a personal video recorder, a personal computer (PC) with television card, etc.

It is particularly advantageous in conjunction with electronic program guides such as provided by OCAP.

For live broadcasts, such as sports events, it will also be possible to provide the indicator data at the end of the television program such that, where the program has been recorded, indexing of highlights, together with representative images, can additionally be recorded.

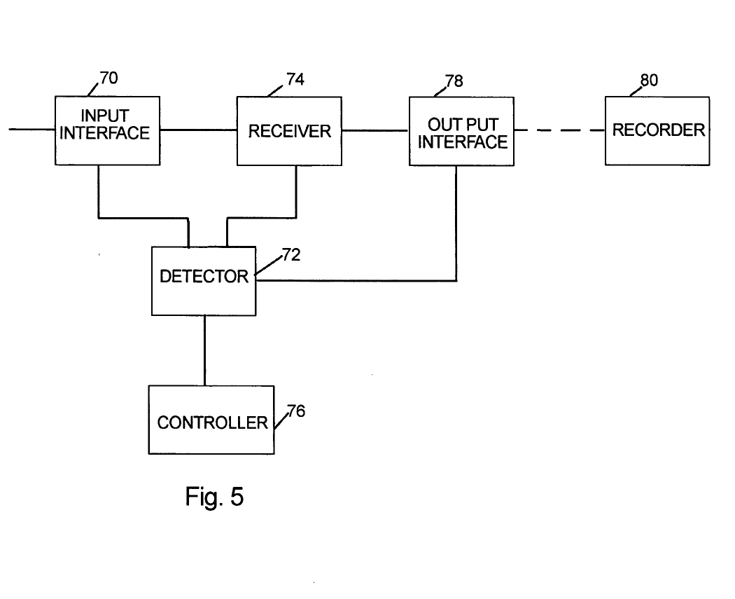

In the embodiment of FIG. 5, the indicator data itself is output for recording with audio/video data for future use in providing representative images.

An input interface 70 is arranged to receive input external data including at least a transmitted stream of video data.

A detector 72 is configured to detect any indicator data in the external data received by the input interface 70.

A receiver 74 obtains, from the external data received by the input interface 70, a stream of video data. The detector 72 may be able to detect received indicator data directly from the input interface 70, for instance where the indicator data is received separately via the internet or a recording medium. However, in some embodiments, the detector 72 may have to refer to the video data obtained by the receiver 74, for instance where the indicator data is provided in vertical blanking periods of the television signal.

A controller 76 is connected to the detector 72.

An output interface 78 is connected to the receiver 74 and allows output of received television programs, for instance to the recorder 80.

The controller 76 is arranged to control the device to output detected indicator data. The detector 72 may extract the required indicator data and provide this to the output interface 78 for output with the video data. Alternatively, the detector 72 could merely provide information to the output interface 78 allowing the output interface 78 to extract the appropriate indicator data for output with the video data

During playback of data recorded by the recorder 80, the indicator data can be used to provide representations, for instance representative images, of the video data recorded by the recorder 80. Where various different video data items are recorded by the recorder 80, indicator data can identify one or more video frames for each respective video data item.

During playback, a graphical user interface may be provided to display the representations obtained by means of the indicator data. In particular, during playback, the indicator data which has been prerecorded on a recording medium by the recorder 80 will be derived from that recording medium for one or more of the respective video data items. Possibly under the control of the graphical user interface application, the video frames required for the representation of respective video data items are identified using the indicator data. In particular, these video frames can be output to an interface accessible by the graphical user interface application.

Indexing data which has been prerecorded on the recording medium by the recorder 80 can also be derived for each of the video data items. Indexing data may include, for a video data item, one or more of a unique or quasi-unique identifier, location/address data for the video item on the recording medium, a title, a category (e.g. movie, entertainment, sport), a time/date of broadcast or availability, a duration of the video data item, a channel or source of broadcast, copyright information, an indicator of user interest or preference, a program note, actor/director information, parental control data or any other item of metadata that may have been broadcast with a video data item, e.g. by multiplexing it with the video stream, or any other item of metadata which may have been associated with the video item by a user and stored on the recording medium. In some embodiments, a user may be able to define which indexing data is displayed in the GUI. Some indexing data may be hidden and hence not displayed in the GUI such as the location/address data.

By using the video frames obtained from the interface, together with the indexing data, it is possible to obtain and then display in the graphical user interface respective representations for the video data items.

1. A video receiver device comprising:
an input interface for receiving external data;
a receiver connected to the input interface for obtaining from said external data a stream of video data for a succession of video frames;
an output interface connected to the receiver for outputting said stream of video data;
a detector for detecting indicator data in the external data, the indicator data indicating at least one frame of the stream of video data for use in representing the video data;
a memory for storing a plurality of video frames;
a data capturer connected to the receiver and the memory and arranged to capture individual video frames from the stream of video data and store captured frames in the memory;
a controller connected to the detector, the data capturer and the memory and responsive to detection by the detector of indicator data to control the data capturer to capture the frames indicated by the detected indicator data and store the captured frames in the memory; and
an image provider connected to the memory, the output interface and the controller, the image provider being responsive to the controller to obtain one or more selected frames from the memory and provide the one or more selected frames to the output interface for use in representing the stream of video data.

2. A video receiver device according to claim 1 wherein:
the controller is configured to provide, in conjunction with the image provider, output data for display of an electronic program guide and is configured to insert, into the electronic program guide, frames indicated by the indicator data for respective programs listed in the electronic program guide.

3. A video receiver device according to claim 2 wherein:
the controller is configured to insert, into the electronic program guide, for respective programs, frames captured from streams of video data for trailers for the programs.

4. A video receiver device according to claim 1 wherein:
for a received stream of video data for a television program, the controller is configured to provide for output, in conjunction with the image provider, index data for the television program including said selected frames for the television program.

5. A video receiver device according to claim 1 wherein:
the memory is arranged to store said plurality of video frames in full resolution as received from the receiver.

6. A video receiver device according to claim 1 wherein:
the controller is configured to produce thumbnail video frames of reduced size and/or resolution for storage as said video frames in said memory.

7. A video receiver device according to claim 1 wherein:
the input interface is arranged to receive external data containing the indicator data from a different source to external data containing said stream of video data.

8. A video receiver device according to claim 1 wherein:
the receiver is arranged to separate external data containing the indicator data from external data containing said stream of video data.

9. A video receiver device according to claim 1 further comprising:
a display for displaying at least said stream of video data.

10. A video receiver device according to claim 1 further comprising:
a recording apparatus for recording at least the stream of video data.

11. A video transmission apparatus comprising:
an input interface for providing, from a source, a stream of video data for a succession of video frames;
an output interface connected to said input interface and arranged to provide the stream of video data for transmission;
a user interface connected to said input interface and arranged to provide a display of video frames of said stream and to enable a user to select particular frames for use in representing the stream; and
an indicator creator connected to the input interface, the user interface and the output interface, wherein the indicator creator is arranged to create, in response to control from the user interface following selection of particular frames by a user, indicator data indicating at least one frame as selected by the user from the stream of video data and to provide the indicator data to the output interface.

12. A video transmission apparatus according to claim 11 wherein:
the output interface is arranged to embed the indicator data in the stream of video data.

13. A video transmission apparatus according to claim 11 wherein:
the output interface is arranged to provide a data stream containing the indicator data for transmission with the stream of video data.

14. A video transmission apparatus according to claim 11 wherein:
the output interface is arranged to provide output data containing the indicator data for transmission separately from the stream of video data.

15. A data-bearing signal representative of indication data provided to the output interface of the video transmission apparatus of claim 11.

16. A method of providing a receiver of a transmitted stream of video data for an ongoing succession of video frames with one or more images representing the stream of video data, the method comprising:
creating indicator data which identifies individual frames in the stream of video data for use as said one or more images; and
transmitting said indicator data to the receiver.

17. A method for identifying one or more video frames in an external stream of video data and for providing data corresponding to one or more frames of the video data stream to an output interface for use in representing a portion of the video data stream, the method comprising the steps of:
receiving the external data stream and deriving the video data stream therefrom,
detecting indicator data in the external data, the indicator data indicating at least one frame of the stream of video data for use in representing the video data,
storing a plurality of video frames;
capturing one or more individual frames in accordance with the detected indicator data, and
providing one or more captured frames to an output interface.

18. A data carrier having stored thereon data portions corresponding to at least one sequence of video frames, table of contents data identifying the data portions and data representing one or more video frames corresponding to at least some data portions, the data representing the one or more video frames being displayable as part of an index display of the contents of the data carrier and having been stored on the data carrier in accordance with the method of claim 17.

19. A video device comprising:
an input interface for receiving external data;
a receiver connected to the input interface for obtaining from said external data a stream of video data for a succession of video frames;
an output interface connected to the receiver for outputting said stream of video data;
a detector for detecting indicator data in the external data, the indicator data indicating at least one frame of the stream of video data for use in representing the video data; and
a controller connected to the detector and arranged to control the detector to provide the indicator data to the output interface for output with said stream of video data.

20. A video device according to claim 19 further comprising:
a recorder arranged to receive from the output interface the stream of video data and the indicator data and to record the stream of video data and the indicator data on a recording medium.

21. A video device comprising:
an input interface for receiving external data;
a receiver connected to the input interface for obtaining from said external data a stream of video data for a succession of video frames;
a detector for detecting indicator data in the external data, the indicator data indicating at least one frame of the stream of video data for use in representing the video data; and
a recorder arranged to receive from the receiver and the detector the stream of video data and indicator data and to record the stream of video data and indicator data on a recording medium.

22. A method for generating a representation of at least one video data item, having a plurality of frames, stored on a recording medium for display using a graphical user interface (GUI), the method comprising the steps of:
launching a GUI application,
deriving, from the recording medium, indexing data for each of the video data items,
deriving, from the recording medium, indicator data indicating at least one frame of video for a respective video data item,
identifying, at least in part under the control of the GUI application, and using the indicator data, at least one frame of video included in the respective video data item,
outputting the at least one frame of video to an interface accessible by the GUI application, and
displaying, in the GUI, a representation of at least one video data item stored on the recording medium, the representation including for the said at least one video data item, one or more frames of video representing the video data item obtained from the said interface and indexing data.
